(19) United States
(12) Patent Application Publication
(10) Pub. No.: US 2021/0354699 A1
(43) Pub. Date: Nov. 18, 2021

(54) INFORMATION PROCESSING APPARATUS, INFORMATION PROCESSING METHOD, AND SYSTEM

(71) Applicant: TOYOTA JIDOSHA KABUSHIKI KAISHA, Toyota-shi (JP)

(72) Inventor: Minako SUGIYAMA, Nisshin-shi (JP)

(73) Assignee: TOYOTA JIDOSHA KABUSHIKI KAISHA, Toyota-shi (JP)

(21) Appl. No.: 17/246,809

(22) Filed: May 3, 2021

(30) Foreign Application Priority Data
May 12, 2020 (JP) 2020-083890

(51) Int. Cl. B60W 30/18; B60W 30/095; B60W 50/00; B60W 50/14

(52) U.S. Cl. CPC B60W 30/18163; B60W 30/0956; B60W 50/0097; B60W 50/14; B60W 2050/0089; B60W 2556/65; B60W 2050/146; B60W 2554/802; B60W 2554/806; B60W 2556/10; B60W 2050/143

(57) ABSTRACT

A controller is provided that is configured to perform: receiving information on travel history of a first vehicle ahead of a subject vehicle from the first vehicle; receiving information on course prediction of a second vehicle from the second vehicle; and predicting a travel route of the second vehicle based on the information on the travel history and the information on the course prediction, and notifying a driver of the subject vehicle, in the case of detecting, based on the travel route of the second vehicle thus predicted, that there is a possibility that the subject vehicle will come into contact with the second vehicle when the subject vehicle overtakes a third vehicle that is ahead of the subject vehicle and behind the first vehicle.

### CROSS REFERENCE TO THE RELATED APPLICATION

This application claims the benefit of Japanese Patent Application No. 2020-083890, filed on May 12, 2020, which is hereby incorporated by reference herein in its entirety.

### BACKGROUND

### Technical Field

The present disclosure relates to an information processing apparatus, an information processing method, and a system.

### Description of the Related Art

There has been known a technique that determines, when overtaking a preceding vehicle, whether or not a vehicle can overtake the preceding vehicle in consideration of an oncoming vehicle (for example, see Patent Literature 1).

### CITATION LIST

### Patent Literature

Patent Literature 1: Japanese Patent Application Laid-Open Publication No. 2008-065481

### SUMMARY

An object of the present disclosure is to provide a driver with information on whether or not an own or subject vehicle can overtake a preceding vehicle, by using information obtained from other vehicles.

One aspect of the present disclosure is directed to an information processing apparatus including a controller configured to perform:

receiving information on travel history of a first vehicle ahead of a subject vehicle from the first vehicle;

receiving information on course prediction of a second vehicle from the second vehicle; and

predicting a travel route of the second vehicle based on the information on the travel history and the information on the course prediction, and notifying a driver of the subject vehicle, in the case of detecting, based on the travel route of the second vehicle thus predicted, that there is a possibility that the subject vehicle will come into contact with the second vehicle when the subject vehicle overtakes a third vehicle that is ahead of the subject vehicle and behind the first vehicle.

Another aspect of the present disclosure is directed to an information processing method for causing a computer to perform:

receiving information on travel history of a first vehicle ahead of a subject vehicle from the first vehicle;

receiving information on course prediction of a second vehicle from the second vehicle; and

predicting a travel route of the second vehicle based on the information on the travel history and the information on the course prediction, and notifying a driver of the subject vehicle, in the case of detecting, based on the travel route of the second vehicle thus predicted, that there is a possibility that the subject vehicle will come into contact with the second vehicle when the subject vehicle overtakes a third vehicle that is ahead of the subject vehicle and behind the first vehicle.

A further aspect of the present disclosure is directed to a system for mutually transmitting and receiving information on travel history and information on course prediction between vehicles, the system including a subject vehicle configured to perform:

receiving information on travel history of a first vehicle ahead of a subject vehicle from the first vehicle;

receiving information on course prediction of a second vehicle from the second vehicle; and

predicting a travel route of the second vehicle based on the information on the travel history and the information on the course prediction, and notifying a driver of the subject vehicle, in the case of detecting, based on the travel route of the second vehicle thus predicted, that there is a possibility that the subject vehicle will come into contact with the second vehicle when the subject vehicle overtakes a third vehicle that is ahead of the subject vehicle and behind the first vehicle.

In addition, a still further aspect of the present disclosure is directed to a program for causing a computer to perform the information processing method, or a computer-readable storage medium storing the program in a non-transitory manner. Also, a yet further aspect of the present disclosure is directed to a vehicle including the information processing apparatus.

According to the present disclosure, it is possible to provide a driver with information on whether or not a subject vehicle can overtake a preceding vehicle, by using information obtained from other vehicles.

### BRIEF DESCRIPTION OF THE DRAWINGS

FIG. 1 is a view illustrating a schematic configuration of a driving assistance system according to a first embodiment;

FIG. 2 is a block diagram schematically illustrating an example of a configuration of a vehicle constituting the driving assistance system;

FIG. 3 is a diagram illustrating an example of a functional configuration of the vehicle;

FIG. 4 is a flowchart of processing of transmitting and receiving information at each vehicle;

FIG. 5 is a flowchart of processing of determining whether or not a subject vehicle can overtake a second preceding vehicle;

FIG. 6 is a view illustrating a schematic configuration of a driving assistance system according to a second embodiment; and

FIG. 7 is a flowchart of processing in the case of determining whether or not a subject vehicle can overtake a second preceding vehicle by using an overtaking route.

### DESCRIPTION OF THE EMBODIMENTS

A controller included in an information processing apparatus according to the present embodiment receives, from a first vehicle, information on travel history of the first vehicle ahead of an own or subject vehicle. The first vehicle is, for example, a vehicle located ahead of the subject vehicle in a direction of travel thereof. Also, the first vehicle may be, for example, a vehicle that can be determined to be traveling ahead of the subject vehicle in the direction of travel of the subject vehicle in the same lane as the subject vehicle. For example, when the subject vehicle is traveling on a route on which another vehicle has traveled in the past, the other vehicle can be specified as the first vehicle traveling ahead of the subject vehicle. The information on the travel history of the first vehicle is information that enables to obtain positions through which the first vehicle has passed or routes through which the first vehicle has passed. The positions through which the first vehicle has passed may be positions which have been detected at predetermined time intervals or positions at which the direction of travel of the first vehicle has changed. In addition, the speed, the direction of travel, or the time point at each position may be associated with that position. The subject vehicle may receive information on the travel history from the first vehicle by using, for example, vehicle to vehicle communication.

In addition, the controller receives, from a second vehicle, information on course prediction of the second vehicle. The second vehicle is a vehicle that is traveling in a place different from a lane in which the subject vehicle travels. The second vehicle is, for example, a vehicle that is traveling in an opposite lane. The second vehicle makes course prediction of the second vehicle by itself, and the subject vehicle receives information about that course prediction. Here, note that not only the second vehicle but also the subject vehicle and the first vehicle may predict their own courses. The course prediction includes a future route or a future position that is estimated based on the current or past state of travel of the second vehicle. For example, the course prediction can be made on the assumption that the current speed and direction of travel of the second vehicle are maintained. However, for example, if the road on which the second vehicle is traveling curves after the course prediction is made, a discrepancy will occur between an actual travel route and a route predicted according to the course prediction. Therefore, in the second vehicle, a course of a relatively short distance is predicted. In this case, it will be difficult to determine, based solely on the course prediction received from the second vehicle, whether or not there is a possibility that the subject vehicle will come into contact with the second vehicle when the subject vehicle overtakes a third vehicle. Here, note that the subject vehicle may receive the information on the course prediction from the second vehicle by using, for example, vehicle to vehicle communication.

The controller predicts a travel route of the second vehicle based on the information on the travel history and the information on the course prediction, and notifies a driver of the subject vehicle when detecting, based on the travel route of the second vehicle thus predicted, that there is a possibility of the subject vehicle coming into contact with the second vehicle at the time when the subject vehicle overtakes the third vehicle that is ahead of the subject vehicle and behind the first vehicle. That is, the route of the second vehicle is predicted based on the information on the travel history of the first vehicle. The route predicted at this time is longer in distance than a route predicted in the course prediction of the second vehicle. For example, the route of the second vehicle may be predicted on the assumption that the second vehicle travels on a route correlated with the travel route of the first vehicle. At this time, the travel route of the second vehicle may be predicted on the assumption that the second vehicle travels in parallel with a past travel route of the first vehicle. A route from the subject vehicle to the first vehicle can be known by using the information on the travel history of the first vehicle, and hence, based on the assumption that the second vehicle travels reversely in parallel with that route, it is possible to predict the route of the second vehicle. Then, based on the route of the second vehicle thus predicted, it is possible to determine whether or not there is a possibility that the subject vehicle will come into contact with the second vehicle. Further, in the case of detecting that there is a possibility of contact, the driver of the subject vehicle can stop overtaking by being notified to that effect. Here, note that the third vehicle is, for example, a vehicle closest to the subject vehicle among other vehicles traveling ahead of the subject vehicle.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

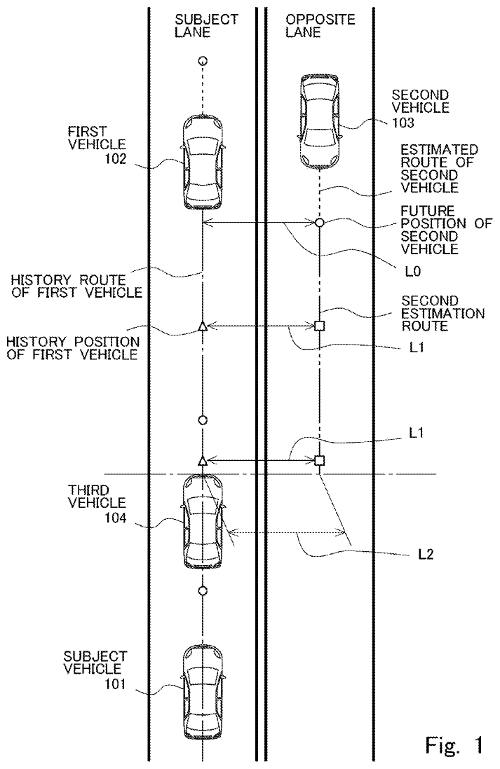

FIG. 1 is a diagram illustrating a schematic configuration of a driving assistance system 1 according to a first embodiment. In FIG. 1, there are illustrated an own or subject vehicle 101, a first vehicle 102, a second vehicle 103, and a third vehicle 104. Hereinafter, in cases where the subject vehicle 101, the first vehicle 102, the second vehicle 103, and the third vehicle 104 are not distinguished from one another, they are simply referred to as vehicles 10. The first vehicle 102 is an example of a first vehicle, the second vehicle 103 is an example of a second vehicle, and the third vehicle 104 is an example of a third vehicle. Each of the vehicles 10 is, for example, a connected car, and they are vehicles capable of making vehicle to vehicle communication (V2V) with each other.

In a lane in which the subject vehicle 101 is traveling (hereinafter, also referred to as an own or subject lane), the first vehicle 102, the third vehicle 104 and the subject vehicle 101 are located in this order. There is a sufficient distance between the first vehicle 102 and the third vehicle 104 to allow the subject vehicle 101 to enter. The third vehicle 104 is a vehicle that the subject vehicle 101 is trying to overtake. On the other hand, in a lane which is parallel with the subject lane and in which the second vehicle 103 is traveling (hereinafter, also referred to as an opposite lane), the second vehicle 103 is traveling in a direction opposite to the subject vehicle 101. The subject vehicle 101 is a vehicle that is going to overtake the third vehicle 104 and to enter behind the first vehicle 102 and in front of the third vehicle 104. In addition, the second vehicle 103 is a vehicle that is going to pass the subject vehicle 101. When the subject vehicle 101 overtakes the third vehicle 104, it is necessary for the subject vehicle 101 to protrude into an opposite lane. Therefore, the subject vehicle 101 may come into contact with the second vehicle 103. Here, note that in the present embodiment, even in cases where the second vehicle 103 is not actually traveling in the opposite lane, it is determined whether or not there is a possibility that the subject vehicle 101 will come into contact with the second vehicle 103.

In each vehicle 10, course prediction and travel history thereof are generated. Then, each vehicle 10 transmits information on the course prediction and information on the travel history to other vehicles. For this communication, there is used vehicle to vehicle communication. However, the communication method is not limited to this. The travel history may include, for example, information indicating a combination of the time point and the position of the vehicle 10 at each predetermined time interval, or information indicating a combination of the time point and the position of the vehicle 10 when the direction in which the vehicle 10 is moving changes. The predetermined time interval referred to herein is enough time to know the route on which the vehicle 10 has traveled in the past. Also, the travel history may be indicated as a line connecting the past positions of the vehicle 10 in the order of time. The travel history is stored in each vehicle 10 and transmitted to other vehicles 10, based on the positions detected by each vehicle 10. In addition, the course prediction includes information indicating a combination of the future positions and time points of the vehicle 10. The course prediction may be indicated by a line connecting the future positions of the vehicle 10 in the order of time. The course prediction is generated in each vehicle 10 based on, for example, the direction of travel and speed of each vehicle 10, and is transmitted to the other vehicles 10. The course prediction is generated, for example, on the assumption that the direction of travel and speed of each vehicle 10 are maintained. Here, note that in the following, a past travel route of each vehicle 10 is also referred to as a history route. The history route may be included in the travel history of each vehicle 10. The course prediction in each vehicle 10 may include a future travel route of each vehicle 10. This future travel route is hereinafter also referred to as an estimated route.

In FIG. 1, the estimated route of each vehicle 10 is indicated by a broken line connecting a white circle in front of each vehicle 10 and each vehicle 10. A white circle indicates a position in future (hereinafter, also referred to as a future position) of each vehicle 10 included in the course prediction generated by each vehicle 10. The future position of each vehicle 10 may be a position of each vehicle 10 after a predetermined time. Also, in FIG. 1, the history route of the first vehicle 102 is indicated by an alternate long and short dash line connecting a plurality of triangle marks. The plurality of triangle marks are, for example, positions of the first vehicle 102 detected at predetermined time intervals in the first vehicle 102. Here, note that in the following description, it is assumed that the respective vehicles 10 transmit and receive the history routes and the estimated routes to and from each other.

The subject vehicle 101 specifies the first vehicle 102 and the third vehicle 104 from among the vehicles 10 that are ahead in the subject lane. In cases where it can be determined that the subject vehicle 101 is traveling on a history route received from another vehicle 10, the vehicle 10 is specified as the first vehicle 102 or the third vehicle 104. For example, the first vehicle 102 may be specified from among the vehicles 10 whose distances from the subject vehicle 101 are equal to or greater than the future position of the second vehicle 103. In addition, for example, a vehicle 10 within a range in which the distance thereof from the subject vehicle 101 is considered to be the distance of a vehicle 10 immediately before the subject vehicle 101 may be specified as the third vehicle 104.

For example, in cases where the subject vehicle 101 is located within a first predetermined distance from the history route of the first vehicle 102 and the direction of travel of the subject vehicle 101 is within a first predetermined range with respect to the direction of travel of the first vehicle 102, it can be determined that the subject vehicle 101 is traveling in the same lane as the first vehicle 102. The first predetermined distance referred to herein is a distance at which it can be determined that the vehicles are traveling on the same lane. The first predetermined distance may be substantially 0. Also, the first predetermined range referred to herein is a range in which the directions of travel of the vehicles are considered to be the same. Similarly, for example, in cases where the third vehicle 104 is located within the first predetermined distance from the history route of the first vehicle 102 and the direction of travel of the third vehicle 104 is within the first predetermined range with respect to the direction of travel of the first vehicle 102, it can be determined that the third vehicle 104 is traveling in the same lane as the first vehicle 102.

In addition, the subject vehicle 101 specifies the second vehicle 103. For example, the subject vehicle 101 specifies, as the second vehicle 103, a vehicle 10 that can be determined to be traveling in the direction opposite to the direction of travel of the first vehicle 102.

Also, the subject vehicle 101 predicts the route of the second vehicle 103 from the history route received from the first vehicle 102 and the estimated route received from the second vehicle 103. In FIG. 1, the route of the second vehicle 103 predicted by the subject vehicle 101 (hereinafter referred to as a second estimated route) is indicated by an alternate long and two short dashes line, and positions or locations on the second estimated route are indicated by square marks. The second estimated route is longer in distance than the estimated route of the second vehicle 103.

The history route of the first vehicle 102 is generated, for example, by storing the position of the first vehicle 102 at each predetermined time interval or each time the direction of travel of the first vehicle 102 changes, and connecting the positions thus stored with each other. As described above, positions stored in the first vehicle 102 correspond to the positions indicated by triangle marks in FIG. 1. Hereinafter, these positions are also referred to as history positions. The second estimated route of the second vehicle 103 is generated by using the history route of the first vehicle 102 (corresponding to the alternate long and short dash line in FIG. 1) or the history positions of the first vehicle 102 (corresponding to the triangle marks in FIG. 1). The history route and the history positions are included in the travel history. For example, the second estimated route of the second vehicle 103 is generated so as to be in parallel with the history route of the first vehicle 102. At this time, the second estimated route is generated on the assumption that a distance L0 between the future position of the second vehicle 103 and the history route of the first vehicle 102 is maintained. Here, note that in FIG. 1, the positions of the second vehicle 103 on the second estimated route corresponding to the positions of the first vehicle 102 on the history route thereof indicated by the triangle marks are indicated by the square marks. A distance L1 between each triangle mark and each corresponding square mark is constant and equal to the distance L0 between the future position of the second vehicle 103 and the history route of the first vehicle 102.

Then, for example, in cases where the distance between the second estimated route and the third vehicle 104 becomes within a second predetermined distance within a predetermined time from the start of an overtaking operation, the subject vehicle 101 detects that it may come into contact with the second vehicle 103. That is, in cases where the distance between the third vehicle 104 and the second vehicle 103 is short at the time when the subject vehicle 101 overtakes the third vehicle 104, it is detected that the subject vehicle 101 may come into contact with the second vehicle 103. The predetermined time referred to herein is the time required for the subject vehicle 101 to overtake the third vehicle 104. In addition, the second predetermined distance is set as a distance between the third vehicle 104 and the second estimated route at which it becomes difficult for the subject vehicle 101 to pass between the third vehicle 104 and the second vehicle 103 when the subject vehicle 101 overtakes the third vehicle 104. That is, the second predetermined distance is a distance at which the second vehicle 103 is considered to be traveling in the opposite lane, and at which the subject vehicle 101 may come into contact with the second vehicle 103 when the subject vehicle 101 protrudes into the opposite lane. When it is detected that there is a possibility that the subject vehicle 101 comes into contact with the second vehicle 103, the subject vehicle 101 notifies the driver thereof to that effect. As a result, the subject vehicle 101 can be prevented from coming into contact with the second vehicle 103 unless the driver thereof performs overtaking.

Here, when determining whether or not the subject vehicle 101 comes into contact with the second vehicle 103 at the time when the subject vehicle 103 protrudes into the opposite lane to overtake the third vehicle 104, it may be determined, for example, whether or not the second vehicle is running in the opposite lane in a direction opposite to the direction of travel of the subject vehicle 101. Then, in order to determine whether or not the second vehicle 103 is traveling in the opposite lane in the direction opposite to that of the subject vehicle 101, map information may be conventionally used. That is, map information is required. On the other hand, in the driving assistance system 1 according to the present embodiment, it is possible to detect that the subject vehicle 101 may come into contact with the second vehicle 103 without using map information.

### (Hardware Configuration)

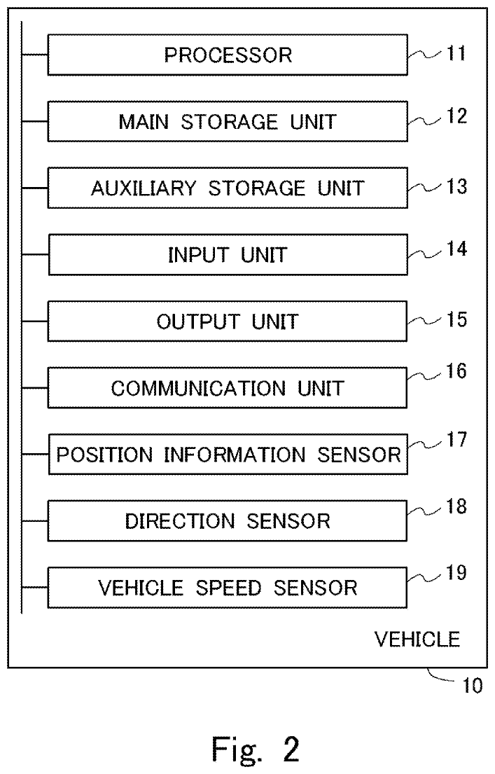

Next, the hardware configuration of each vehicle 10 will be described based on FIG. 2. FIG. 2 is a block diagram schematically illustrating an example of the configuration of each of the vehicles 10 constituting the driving assistance system 1. This configuration is common to the subject vehicle 101, the first vehicle 102, the second vehicle 103, and the third vehicle 104.

The vehicle 10 includes a processor 11, a main storage unit 12, an auxiliary storage unit 13, an input unit 14, an output unit 15, a communication unit 16, a position information sensor 17, a direction sensor 18, and a vehicle speed sensor 19. These components are connected to one another by means of a bus. The processor 11 is a CPU (Central Processing Unit), a DSP (Digital Signal Processor), or the like. The processor 11 performs various information processing operations for controlling the vehicle 10. The processor 11 is an example of a controller.

The main storage unit 12 is a RAM (Random Access Memory), a ROM (Read Only Memory), or the like. The auxiliary storage unit 13 is an EPROM (Erasable Programmable ROM), a hard disk drive (HDD), a removable medium, or the like. The auxiliary storage unit 13 stores an operating system (OS), various programs, various tables, and the like. The processor 11 loads a program stored in the auxiliary storage unit 13 into a work area of the main storage unit 12 and executes the program, so that each component or the like is controlled through the execution of the program. The main storage unit 12 and the auxiliary storage unit 13 are computer-readable recording media. The configuration illustrated in FIG. 2 may be such that a plurality of computers cooperate with one another. In addition, the information stored in the auxiliary storage unit 13 may be stored in the main storage unit 12. On the other hand, the information stored in the main storage unit 12 may be stored in the auxiliary storage unit 13.

The input unit 14 is a means or unit for receiving an input operation performed by a user, and is, for example, a touch panel, a keyboard, a mouse, a push button, or the like. The output unit 15 is a means or unit that serves to present information to the user, and is, for example, an LCD (Liquid Crystal Display), an EL (Electroluminescence) panel, a speaker, a lamp, or the like. The input unit 14 and the output unit 15 may be configured as a single touch panel display. The communication unit 16 is a means or unit that performs vehicle to vehicle communication. The communication unit 16 is, for example, a circuit for communicating with other vehicles 10.

The position information sensor 17 obtains position information (i.e., latitude and longitude) of the vehicle 10 at predetermined intervals. The position information sensor 17 is, for example, a GPS (Global Positioning System) receiver unit, a wireless LAN communication unit, or the like. The information obtained by the position information sensor 17 is recorded in, for example, the auxiliary storage unit 13 or the like. The direction sensor 18 obtains a direction in which the vehicle 10 faces, at predetermined intervals. The direction sensor 18 includes, for example, a geomagnetic sensor, a gyro sensor, or the like. The information obtained by the direction sensor 18 is recorded in, for example, the auxiliary storage unit 13 or the like. The vehicle speed sensor 19 is a sensor that detects the speed of the vehicle 10 at predetermined intervals. The information obtained by the vehicle speed sensor 19 is stored in, for example, the auxiliary storage unit 13 or the like.

Here, note that a series of processing performed in the vehicle 10 may be performed by hardware or may be executed by software. The hardware configuration of the vehicle 10 is not limited to that illustrated in FIG. 2.

### (Functional Configuration: Vehicle)

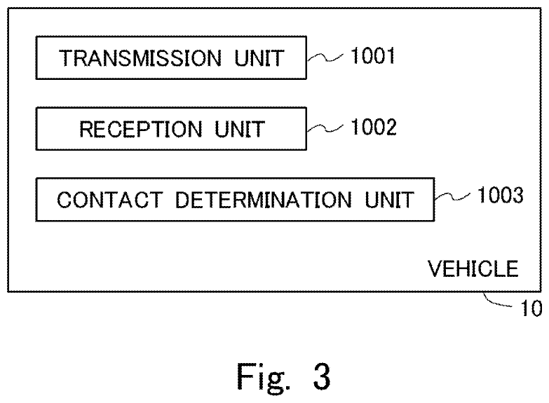

FIG. 3 is a diagram illustrating an example of a functional configuration of the vehicle 10. The vehicle 10 includes, as its functional components, a transmission unit 1001, a reception unit 1002, and a contact determination unit 1003. The transmission unit 1001, the reception unit 1002, and the contact determination unit 1003 are functional components that are provided by, for example, the processor 11 of the vehicle 10 executing various programs stored in the auxiliary storage unit 13.

The transmission unit 1001 generates information on the course prediction and information on the travel history of the vehicle 10, and transmits the information to other vehicles 10. The course prediction includes a future position or an estimated route. For example, assuming that the speed and the direction of travel of the vehicle 10 at the current time point are maintained, the transmission unit 1001 generates the future position by estimating the position of the vehicle 10 after a predetermined time. In addition, the estimated route is generated by connecting the current position to the future position by a straight line. The estimated route may include information on the time point at which the vehicle 10 is estimated to pass through each point on the estimated route. The information on the course prediction may include information on the speed and the position of the vehicle 10 at the current time point, or information on the direction of travel of the vehicle 10 at the current time point.

In addition, the history route includes information on the time point when each point on the history route is passed. Here, note that the history route may be position information at each predetermined time point. Each vehicle 10 transmits the current location, the course prediction, and the travel history of the vehicle 10 to other vehicles 10 in association with its vehicle ID. At this time, the information on the speed of the vehicle 10 and the information on the direction of travel of the vehicle 10 at the current time point may together be transmitted to the other vehicles 10.

On the other hand, the reception unit 1002 receives the information on the course prediction and the information on the travel history from the other vehicles 10, and stores the information thus received in the auxiliary storage unit 13.

The contact determination unit 1003 determines, based on the information on the travel history received from the first vehicle 102 and the information on the course prediction received from the second vehicle 103, whether or not the subject vehicle 101 is likely to come into contact with the second vehicle 103, in the case of assuming that the subject vehicle 101 overtakes the third vehicle 104. Therefore, the contact determination unit 1003 specifies the first vehicle 102, the second vehicle 103, and the third vehicle 104.

The contact determination unit 1003 specifies, as the first vehicle 102, another vehicle 10 that satisfies a condition that a distance between the history route received from the other vehicle 10 and the position of the subject vehicle 101 is within a first predetermined distance and the direction of travel of the subject vehicle 101 is within a first predetermined range with respect to the direction of travel of the other vehicle 10. The first predetermined distance referred to herein is a distance at which it can be determined that the vehicles are traveling on the same lane. Also, the first predetermined range referred to herein is a range of the direction of travel in which it can be determined that the directions of travel of the vehicles are the same. For example, the contact determination unit 1003 may specify the first vehicle 102 from among the vehicles 10 that are farther away from the subject vehicle 101 than the future position of the second vehicle 103. In this case, it is possible to generate the second estimated route of the second vehicle 103 by using the already existing history route. In addition, the first vehicle 102 is selected from among the vehicles 10 that are traveling two or more vehicles ahead of the subject vehicle 101. That is, the first vehicle 102 is specified from among the vehicles 10 traveling ahead of the third vehicle 104. Also, a vehicle 10, which satisfies a condition that the direction of travel of the subject vehicle 101 is within the first predetermined range with respect to the direction of travel of the other vehicle 10 and which travels one vehicle ahead of (i.e., immediately before) the subject vehicle 101, is specified as the third vehicle 104. The vehicle 10 traveling immediately ahead of the subject vehicle 101 may be determined based on the position information of each vehicle 10.

Moreover, the contact determination unit 1003 specifies, as the second vehicle 103, another vehicle 10 that is traveling in a direction within a second predetermined range different from the direction of travel of the first vehicle 102. The second predetermined range referred to herein is a range of the direction of travel that can be determined to be the direction opposite to the direction of travel of the first vehicle 102. The direction of travel of the first vehicle 102 may be the past direction of travel of the first vehicle 102 at a position on the history route closest to the second vehicle 103. In addition, the second vehicle 103 may be specified, for example, from among the vehicles 10 that are located in the direction of potential contact with the direction of travel of the subject vehicle 101. Here, note that when considering that the direction of travel of the first vehicle 102 and the direction of travel of the subject vehicle 101 are the same, the third vehicle 104 or the second vehicle 103 may be specified based on the relation between the direction of travel of the subject vehicle 101 and the direction of travel of each of the vehicles 10.

Further, the contact determination unit 1003 generates the second estimated route of the second vehicle 103 on the assumption that the second vehicle 103 travels in the direction opposite to the first vehicle 102 in parallel with the history route of the first vehicle 102. The second estimated route is a route at the time of assuming that the second vehicle 103 has traveled further ahead from the future position of the second vehicle 103. When generating the second estimated route of the second vehicle 103, the contact determination unit 1003 generates the second estimated route on the assumption that the speed of the second vehicle 103 at the current time point is maintained thereafter. The starting point of the second estimated route is the future position of the second vehicle 103. The starting point of the second estimated route may be set as the current position of the second vehicle 103.

For example, the second estimated route includes information on the time point at which the second vehicle 103 passes through each point on the second estimated route (each point indicated by each square mark in FIG. 1). As illustrated in FIG. 1, the history route is generated by indicating the positions of the third vehicle 104 at predetermined time intervals with triangle marks, and connecting these triangle marks with straight lines in order. The second estimated route is indicated by a line connecting square marks corresponding to the triangle marks in order. The points indicated by the square marks on the second estimated route are determined such that the distance L1 between each history position (triangle mark) and each corresponding square mark on the second estimated route in FIG. 1 is equal to the distance L0 between the future position (circle mark) of the second vehicle 103 and the history route (the alternate long and short dash line) in FIG. 1. Then, the time points at which the second vehicle 103 passes through the square marks in FIG. 1 are calculated based on the speed of the second vehicle 103 at the current time point.

Then, in cases where the distance between the second estimated route and the third vehicle 104 becomes within the second predetermined distance within the predetermined time after the driver starts the overtaking operation, the contact determination unit 1003 determines that there is a possibility of the subject vehicle 101 coming into contact with the second vehicle 103. The predetermined time referred to herein is the time required for the subject vehicle 101 to overtake the third vehicle 104, and is set based on, for example, an average value or a maximum value of the times required for overtaking in the past.

Instead of the above-described determination, for example, in cases where the distance between the second estimated route and the third vehicle 104 (see L2 in FIG. 1) becomes the closest within a predetermined time after the driver starts the overtaking operation and this distance (see L2 in FIG. 1) allows to determine that the second vehicle 103 is traveling in the opposite lane, a determination may be made that there is a possibility that the subject vehicle 101 and the second vehicle 103 will come into contact with each other. The predetermined time referred to herein is also the time required for the subject vehicle 101 to overtake the third vehicle 104. The distance at which it can be determined that the second vehicle 103 is traveling in the opposite lane has been set in advance. This distance may be a distance at which the subject vehicle 101 is likely to come into contact with the second vehicle 103 in the case where the subject vehicle 101 protrudes into the opposite lane in the existence of the second vehicle 103. In this way, in cases where it can be determined that the second vehicle 103 becomes the closest to the third vehicle 104 and the second vehicle 103 is traveling in the opposite lane within the time required for the subject vehicle 101 to overtake the third vehicle 104, it is considered that the distance between the subject vehicle 101 and the second vehicle 103 at the time of overtaking becomes very short, and hence, the contact determination unit 1003 determines that there is a possibility of contact between the subject vehicle 101 and the second vehicle 103.

The contact determination unit 1003 may determine that the driver of the subject vehicle 101 has started the overtaking operation, for example, when the driver operates a direction indicator. Then, the processing of determining whether or not there is a possibility of the subject vehicle 101 coming into contact with the second vehicle 103 is started by using, as a trigger, the fact that the driver has operated the direction indicator. Further, the contact determination unit 1003 guides the driver with information on the result of the determination via the output unit 15. For example, in cases where the contact determination unit 1003 determines that there is a possibility that the vehicle 101 will come into contact with the second vehicle 103, the driver will be informed of the possibility of contact by sound, light, display on the screen, or the like. On the other hand, in cases where it is determined that there is no possibility that the subject vehicle 101 will come into contact with the second vehicle 103, for example, this fact is displayed on the screen. Here, note that in cases where it is determined that there is no possibility of contact, a notification to the driver is not necessarily required.

### (Flow of Processing: Transmission and Reception of Information)

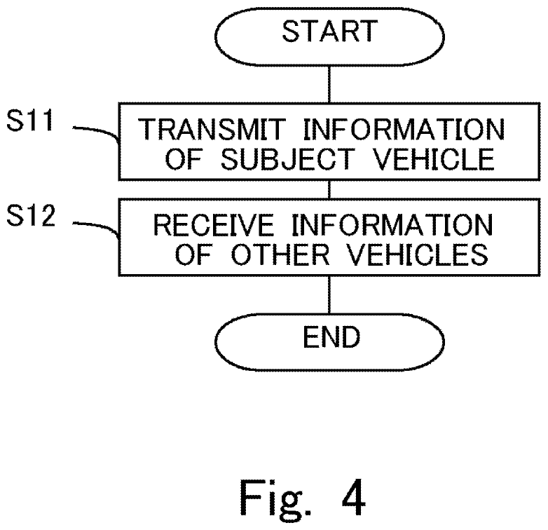

Now, a flow of the processing of transmitting and receiving information in each vehicle 10 will be described. FIG. 4 is a flowchart of the processing of transmitting and receiving information in each vehicle 10. This routine is executed at predetermined time intervals in each vehicle 10.

In step S11, the transmission unit 1001 generates information on the travel history of the subject vehicle 101 and information on the course prediction of the subject vehicle 101, and transmits the information thus generated to other vehicles 10. In addition, in step S21, the reception unit 1002 receives information on the travel history and information on the course prediction from the other vehicles 10.

### (Flow of Processing: When Overtaking)

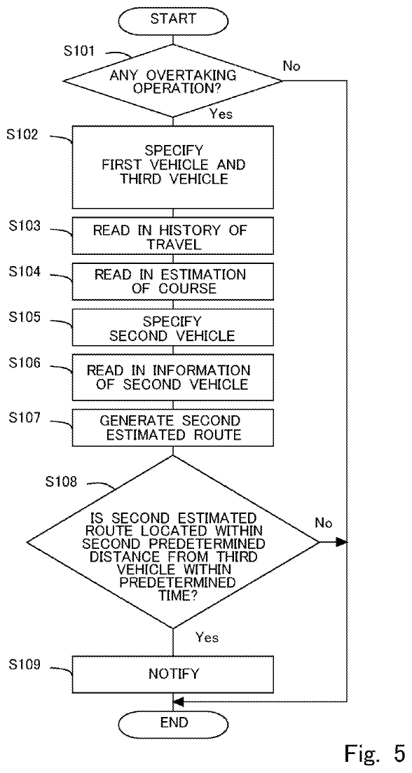

Next, a flow of the processing of determining whether or not the subject vehicle 101 can overtake the third vehicle 104 will be described. FIG. 5 is a flowchart of the processing of determining whether or not the subject vehicle 101 can overtake the third vehicle 104. In the following description, it is assumed that the subject vehicle 101 receives information such as estimated route, history route, position, vehicle speed, direction of travel, etc., from each vehicle 10 as needed, and that such information has been stored in the auxiliary storage unit 13. This routine is executed by the contact determination unit 1003 at predetermined time intervals.

In step S101, the contact determination unit 1003 determines whether or not the driver has performed an overtaking operation in the subject vehicle 101. The overtaking operation is an operation accompanying or associated with overtaking, and includes, for example, a case where the direction indicator has been operated by the driver, a case where the steering wheel has been turned in the direction of the opposite lane, or the like. When an affirmative determination is made in step S101, the processing or routine proceeds to step S102, whereas when a negative determination is made, the present routine is ended.

In step S102, the contact determination unit 1003 specifies the first vehicle 102 and the third vehicle 104. The third vehicle 104 may be a vehicle that is the closest to the subject vehicle 101 among the vehicles 10 that are present in the direction of travel of the subject vehicle 101. The contact determination unit 1003 specifies the third vehicle 104 based on the position information of each vehicle 10. Also, the contact determination unit 1003 specifies the first vehicle 102 based on the history route, the current location, and the direction of travel of each vehicle 10. The contact determination unit 1003 determines, as a candidate for the first vehicle 102, a vehicle 10 that has a history route within the first predetermined distance from the current position of the subject vehicle 101, and that is farther from the subject vehicle 101 than the third vehicle 104 and is also farther from the subject vehicle 101 than the second vehicle 103. Further, the first vehicle 102 is specified on the condition that the direction of travel of the subject vehicle 101 is within the first predetermined range with respect to the direction of travel of the first vehicle 102. In cases where there are a plurality of candidates for the first vehicle 102, for example, a vehicle 10 closest to the subject vehicle 101 among the vehicles 10 satisfying the above condition may be specified as the first vehicle 102, or the first vehicle 102 may be specified at random.

In step S103, the contact determination unit 1003 reads in the information on the travel history received from the first vehicle 102 (which may be a history route). The information on the travel history includes, for example, position information of the first vehicle 102 at predetermined time intervals. The history route received from the first vehicle 102 has been stored in the auxiliary storage unit 13, and hence, the contact determination unit 1003 reads in the history route of the first vehicle 102 from the auxiliary storage unit 13.

In step S104, the contact determination unit 1003 reads in the information on the course prediction received from the third vehicle 104 (which may be an estimated route). The information on the course prediction is the information received by the reception unit 1002, and includes information on each of the position, the speed, and the direction of travel of the third vehicle 104. The information received from the third vehicle 104 has been stored in the auxiliary storage unit 13.

In step S105, the contact determination unit 1003 specifies the second vehicle 103. The contact determination unit 1003 specifies, as the second vehicle 103, a vehicle 10 that is traveling in a direction within the second predetermined range different from the direction of travel of the first vehicle 102. The direction within the second predetermined range may be a direction that can be determined as a direction opposite to the direction of travel of the first vehicle 102.

In step S106, the contact determination unit 1003 reads in the information received from the second vehicle 103. This information is the information received by the reception unit 1002, and includes information on the estimated route, position, speed, and direction of travel of the second vehicle 103. This information has been stored in the auxiliary storage unit 13.

In step S107, the contact determination unit 1003 generates the second estimated route of the second vehicle 103. The contact determination unit 1003 generates the second estimated route of the second vehicle 103 on the assumption that the second vehicle 103 travels in parallel with the history route of the first vehicle 102 from the future position (the circle mark in FIG. 1) of the second vehicle 103. At this time, it is assumed that the second vehicle 103 maintains the current speed.

In step S108, the contact determination unit 1003 determines whether or not the distance between the second estimated route and the third vehicle 104 becomes within the second predetermined distance within a predetermined time from the start of the overtaking operation. The predetermined time is the time required for the subject vehicle 101 to overtake the third vehicle 104. When an affirmative determination is made in step S108, the processing or routine proceeds to step S109, whereas when a negative determination is made, the present routine is ended.

In step S109, the contact determination unit 1003 notifies the driver that there is a possibility of the subject vehicle 101 coming into contact with the second vehicle 103. For example, the driver may be notified to that effect by voice from a speaker. Also, the driver may be notified by sounding a warning sound. In addition, the driver may be notified by lighting a warning lamp.

As described above, according to the present embodiment, when the subject vehicle 101 overtakes the third vehicle 104, it is possible to determine, based on the information on the travel history provided from the first vehicle 102 and the information on the course prediction provided from the second vehicle 103, whether or not there is a possibility that the subject vehicle 101 will come into contact with the second vehicle 103. Then, when it is detected that there is a possibility that the subject vehicle 101 will come into contact with the second vehicle 103, the driver is notified of the possibility, thus making it possible to suppress the subject vehicle 101 from coming into contact with the second vehicle 103. In addition, since the second estimated route is longer in distance than the estimated route provided from the second vehicle 103, it is possible to more accurately determine the possibility of contact between the subject vehicle 101 and the second vehicle 103. Further, it is possible to determine whether or not there is a possibility that the subject vehicle 101 will come into contact with the second vehicle 103, without determining whether or not the second vehicle 103 is actually traveling in the opposite lane. Therefore, even in cases where there is no map information or the like in the subject vehicle 101, it is possible to determine whether or not there is a possibility that the subject vehicle 101 will come into contact with the second vehicle 103. In this way, it is possible to provide the driver with information on whether or not to overtake, by using information obtained from other vehicles 10.

### Second Embodiment

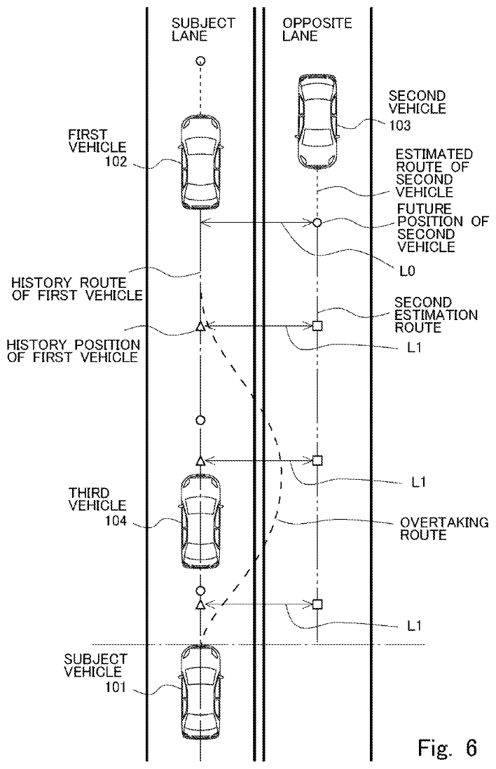

FIG. 6 is a schematic configuration of a driving assistance system 1 according to a second embodiment. In this second embodiment, a route at the time when the subject vehicle 101 overtakes the third vehicle 104 is predicted, and it is determined, based on a distance between this route and the second estimated route of the second vehicle 103, whether or not there is a possibility that the subject vehicle 101 will come into contact with the second vehicle 103. The route predicted at the time when the subject vehicle 101 overtakes the third vehicle 104 is hereinafter also referred to as an overtaking route. For example, a distance between a point (location) on the overtaking route at each time point and a point (location) on the second estimated route at the same time point is compared with a third predetermined distance, and when the distance is within the third predetermined distance, it is detected that there is a possibility that the subject vehicle 101 will come into contact with the second vehicle 103. In this case, the subject vehicle 101 notifies the driver to that effect. Here, note that the third predetermined distance is a distance at which the subject vehicle 101 and the second vehicle 103 may come into contact with each other.

As compared with the first embodiment, this second embodiment differs therefrom in the contact determination unit 1003. The contact determination unit 1003 of the second embodiment determines whether or not there is a possibility that the subject vehicle 101 will come into contact with the second vehicle 103 at the time when the subject vehicle 101 overtakes the third vehicle 104. This determination is made based on the information on the travel history received from the first vehicle 102 and the information on the course prediction received from the second vehicle 103. As described in the first embodiment, the contact determination unit 1003 generates the second estimated route of the second vehicle 103 on the assumption that the second vehicle 103 travels in parallel with the history route of the first vehicle 102 in the opposite direction to the first vehicle 102. The second estimated route is a route when assuming that the second vehicle 103 has traveled further ahead from the future position of the second vehicle 103. Here, note that the history route and the second estimated route are generated in the same manner as in the first embodiment.

In addition, the contact determination unit 1003 generates an overtaking route of the subject vehicle 101. The overtaking route is a route along which the subject vehicle 101 is predicted to travel at the time of overtaking the third vehicle 104, when assuming that the vehicle speed and the direction of travel of the third vehicle 104 at the current time point are maintained. For example, the overtaking route is generated on the assumption that the speed of the subject vehicle 101 is higher by a predetermined speed than the speed of the third vehicle 104 during traveling the overtaking route. The overtaking route is generated so that, for example, the distance between the subject vehicle 101 and the third vehicle 104 becomes an allowable value at the time of overtaking. The allowable value is, for example, the distance required for the subject vehicle 101 to safely overtake the third vehicle 104, and is set, for example, according to the speed of the third vehicle 104.

Then, when the distance between the position of the subject vehicle 101 at each time point on the overtaking route and the position of the second vehicle 103 on the second estimated route at the corresponding time point may become within the third predetermined distance, the contact determination unit 1003 detects that the subject vehicle 101 may come into contact with the second vehicle 103. For example, the contact determination unit 1003 starts the processing of determining whether or not the subject vehicle 101 will come into contact with the second vehicle 103, by using as a trigger the fact that the driver has operated a direction indicator. Further, the contact determination unit 1003 guides or notifies the driver via the output unit 15 about whether or not the third vehicle 104 can be overtaken. A method of notification is the same as that in the first embodiment.

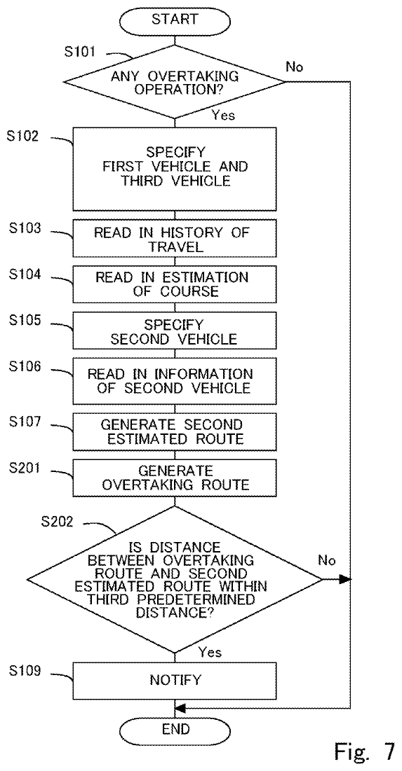

FIG. 7 is a flowchart of the processing of determining whether or not the subject vehicle 101 can overtake the third vehicle 104, by using the overtaking route. In the following description, it is assumed that the subject vehicle 101 receives information such as estimated route, history route, position, vehicle speed, direction of travel, etc., from each vehicle 10 as needed, and that such information has been stored in the auxiliary storage unit 13. In the flowchart illustrated in FIG. 7, the processing of step S108 in the flowchart illustrated in FIG. 5 is not performed, and instead, the processing of step S201 and step S202 is performed. The other steps in FIG. 7 are the same as those in the flowchart illustrated in FIG. 5, and hence, the same steps are denoted by the same reference symbols, and the description thereof is omitted. This routine is executed by the contact determination unit 1003 at predetermined time intervals.

In the flowchart illustrated in FIG. 7, after the processing of step S107, the routine proceeds to step S201. In step S201, the contact determination unit 1003 generates an overtaking route of the subject vehicle 101. The overtaking route is set as a route along which the subject vehicle 101 overtakes the third vehicle 104, based on the speed and position of the subject vehicle 101 and the speed and position of the third vehicle 104. The overtaking route is generated such that, for example, the distance between the subject vehicle 101 and the third vehicle 104 becomes an allowable value at the time of overtaking. In addition, the overtaking route is generated such that the subject vehicle 101 eventually returns to the history route of the first vehicle 102 and the subject vehicle 101 enters the lane in the front of the third vehicle 104. The overtaking route may include, for example, information on the positions of the subject vehicle 101 at respective time points at predetermined time intervals, and information on lines connecting the positions in order. Here, note that the overtaking route may be different for each driver due to the driver's habit or the like, and hence, for example, the overtaking route may be obtained by machine learning. Also, a known technique may be used to generate the overtaking route.

In step S202, the contact determination unit 1003 determines whether or not the distance between the overtaking route of the subject vehicle 101 and the second estimated route of the second vehicle 103 is within the third predetermined distance. In this step S202, the contact determination unit 1003 calculates the distance between the subject vehicle 101 and the second vehicle 103 at each time point based on the position of the subject vehicle 101 on the overtaking route and the position of the second vehicle 103 on the second estimated route at each time point, and determines whether or not the shortest one of the distances is within the third predetermined distance. Then, in cases where the shortest distance is within the third predetermined distance, it is determined that there is a possibility that the subject vehicle 101 will come into contact with the second vehicle 103. When an affirmative determination is made in step S202, the routine proceeds to step S109, whereas when a negative determination is made, the present routine is ended. Here, note that when a negative determination is made, the driver may be notified that overtaking is possible.

As described above, according to this second embodiment, a determination as to whether or not there is a possibility of the subject vehicle 101 coming into contact with the second vehicle 103 is made in consideration of the overtaking route of the subject vehicle 101, so that it is possible to further improve the determination accuracy. In this way, according to this second embodiment, too, it is possible to provide the driver with information on whether or not to overtake, by using information obtained from other vehicles 10.

### Other Embodiments

The above-described embodiments are merely examples, but the present disclosure can be implemented with appropriate modifications without departing from the spirit thereof.

The processing and means (devices, units, etc.) described in the present disclosure can be freely combined and implemented as long as no technical contradiction occurs.

In addition, the processing described as being performed by a single device or unit may be shared and performed by a plurality of devices or units. Alternatively, the processing described as being performed by different devices or units may be performed by a single device or unit. In a computer system, it is possible to flexibly change the hardware configuration (server configuration) that can achieve each function of the computer system.

In the above-described embodiments, vehicles directly communicate with one another by vehicle to vehicle communication, but instead of this, communication may be performed via communication means provided on a road.

The present disclosure can also be realized by supplying to a computer a computer program in which the functions described in the above-described embodiments are implemented, and reading out and executing the program by means of one or more processors included in the computer. Such a computer program may be provided to a computer by a non-transitory computer readable storage medium connectable to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read only memory (ROM), a random access memory (RAM), an EPROM, an EEPROM, a magnetic card, a flash memory, an optical card, or any type of medium suitable for storing electronic commands or instructions.

What is claimed is:

1. An information processing apparatus including a controller configured to perform:
receiving information on travel history of a first vehicle ahead of a subject vehicle from the first vehicle;
receiving information on course prediction of a second vehicle from the second vehicle; and
predicting a travel route of the second vehicle based on the information on the travel history and the information on the course prediction, and notifying a driver of the subject vehicle, in the case of detecting, based on the travel route of the second vehicle thus predicted, that there is a possibility that the subject vehicle will come into contact with the second vehicle when the subject vehicle overtakes a third vehicle that is ahead of the subject vehicle and behind the first vehicle.

2. The information processing apparatus according to claim 1, wherein
the controller specifies, as the first vehicle, another vehicle that satisfies a condition that a distance between a past travel route included in the information on the travel history received from the other vehicle and a position of the subject vehicle is within a first predetermined distance and a direction of travel of the subject vehicle is within a first predetermined range with respect to a direction of travel included in the information on the travel history received from the other vehicle.

3. The information processing apparatus according to claim 1, wherein
the controller specifies, as the second vehicle, another vehicle that satisfies a condition that a direction of travel included in the information on the course prediction received from the other vehicle is within a second predetermined range different from a direction of travel of the first vehicle.

4. The information processing apparatus according to claim 1, wherein
the controller predicts the travel route of the second vehicle on the assumption that the second vehicle travels on a route correlated with a past travel route included in the information on the travel history of the first vehicle.

5. The information processing apparatus according to claim 1, wherein
the controller predicts the travel route of the second vehicle on the assumption that the second vehicle travels in parallel with a past travel route included in the information on the travel history of the first vehicle.

6. The information processing apparatus according to claim 4, wherein
the controller detects that there is a possibility of the subject vehicle coming into contact with the second vehicle, when a distance between a second estimated route, which is a route obtained by predicting the travel route of the second vehicle, and the third vehicle becomes within a second predetermined distance during the time when the subject vehicle is overtaking the third vehicle.

7. The information processing apparatus according to claim 4, wherein
the controller generates an overtaking route that is a route at the time when the subject vehicle overtakes the third vehicle, and detects that there is a possibility of the subject vehicle coming into contact with the second vehicle, when a distance between a second estimated route, which is a route obtained by predicting the travel route of the second vehicle, and the overtaking route becomes within a third predetermined distance.

8. The information processing apparatus according to claim 4, wherein
when predicting the travel route of the second vehicle, the controller assumes that a current speed of the second vehicle is maintained.

9. An information processing method for causing a computer to perform:
receiving information on travel history of a first vehicle ahead of a subject vehicle from the first vehicle;
receiving information on course prediction of a second vehicle from the second vehicle; and
predicting a travel route of the second vehicle based on the information on the travel history and the information on the course prediction, and notifying a driver of the subject vehicle, in the case of detecting, based on the travel route of the second vehicle thus predicted, that there is a possibility that the subject vehicle will come into contact with the second vehicle when the subject vehicle overtakes a third vehicle that is ahead of the subject vehicle and behind the first vehicle.

10. The information processing method according to claim 9, wherein
the computer specifies, as the first vehicle, another vehicle that satisfies a condition that a distance between a past travel route included in the information on the travel history received from the other vehicle and a position of the subject vehicle is within a first predetermined distance and a direction of travel of the subject vehicle is within a first predetermined range with respect to a direction of travel included in the information on the travel history received from the other vehicle.

11. The information processing method according to claim 9, wherein
the computer specifies, as the second vehicle, another vehicle that satisfies a condition that a direction of travel included in the information on the course prediction received from the other vehicle is within a second predetermined range different from a direction of travel of the first vehicle.

12. The information processing method according to claim 9, wherein
the computer predicts the travel route of the second vehicle on the assumption that the second vehicle travels on a route correlated with a past travel route included in the information on the travel history of the first vehicle.

13. The information processing method according to claim 9, wherein
the computer predicts the travel route of the second vehicle on the assumption that the second vehicle travels in parallel with a past travel route included in the information on the travel history of the first vehicle.

14. The information processing method according to claim 12, wherein
the computer detects that there is a possibility of the subject vehicle coming into contact with the second vehicle, when a distance between a second estimated route, which is a route obtained by predicting the travel route of the second vehicle, and the third vehicle becomes within a second predetermined distance during the time when the subject vehicle is overtaking the third vehicle.

15. The information processing method according to claim 12, wherein
the computer generates an overtaking route that is a route at the time when the subject vehicle overtakes the third vehicle, and detects that there is a possibility of the subject vehicle coming into contact with the second vehicle, when a distance between a second estimated route, which is a route obtained by predicting the travel route of the second vehicle, and the overtaking route becomes within a third predetermined distance.

16. The information processing method according to claim 12, wherein
when predicting the travel route of the second vehicle, the computer assumes that a current speed of the second vehicle is maintained.

17. A system for mutually transmitting and receiving information on travel history and information on course prediction between vehicles, the system including a subject vehicle configured to perform:
receiving information on travel history of a first vehicle ahead of the subject vehicle from the first vehicle;
receiving information on course prediction of a second vehicle from the second vehicle; and
predicting a travel route of the second vehicle based on the information on the travel history and the information on the course prediction, and notifying a driver of the subject vehicle, in the case of detecting, based on the travel route of the second vehicle thus predicted, that there is a possibility that the subject vehicle will come into contact with the second vehicle when the subject vehicle overtakes a third vehicle that is ahead of the subject vehicle and behind the first vehicle.

18. The system according to claim 17, wherein
the subject vehicle specifies, as the first vehicle, another vehicle that satisfies a condition that a distance between a past travel route included in the information on the travel history received from the other vehicle and a position of the subject vehicle is within a first predetermined distance and a direction of travel of the subject vehicle is within a first predetermined range with respect to a direction of travel included in the information on the travel history received from the other vehicle.

19. The system according to claim 17, wherein
the subject vehicle specifies, as the second vehicle, another vehicle that satisfies a condition that a direction of travel included in the information on the course prediction received from the other vehicle is within a second predetermined range different from a direction of travel of the first vehicle.

20. The system according to claim 17, wherein
the subject vehicle predicts the travel route of the second vehicle on the assumption that the second vehicle travels on a route correlated with a past travel route included in the information on the travel history of the first vehicle.
